(19) United States
(12) Patent Application Publication
(10) Pub. No.: US 2024/0394550 A1
(43) Pub. Date: Nov. 28, 2024

(54) Data Transfer for a Hardware Accelerator

(71) Applicant: RapidSilicon US, Inc, Los Gatos, CA (US)

(72) Inventor: Behnam GHAVAMI, Los Angeles, CA (US)

(21) Appl. No.: 18/422,959

(22) Filed: Jan. 25, 2024

Related U.S. Application Data
(60) Provisional application No. 63/481,575, filed on Jan. 25, 2023.

(51) Int. Cl. G06N 3/09

(52) U.S. Cl. CPC G06N 3/09

(57) ABSTRACT

Technology is described for data transfer when processing a deep neural network. The method can include receiving a plurality of parameters for a deep neural network at an accelerator having local memory. Another operation may be identifying portions of the plurality of parameters which are able to be independently calculated by the accelerator. Portions of a plurality of parameters may be ordered for execution based in part on computation independence. The portions of the plurality of parameters and associated input data for the portions of the plurality of parameters can be stored in local memory associated with the accelerator. A further operation can be executing a portion of the deep neural network using the portion of the plurality of parameters for the independent portion and associated input data in the accelerator to provide output data with reduced data retrieval while processing the portion of the plurality of parameters.

### PRIORITY CLAIM

Priority is claimed to U.S. Provisional Patent Application No. 63/481,575, entitled “Data Transfer for a Hardware Accelerator” and filed Jan. 25, 2023, which is incorporated herein by reference.

### BACKGROUND

One possible driving force behind the surge of edge computing in the computing industry may be traced back to the opportunity to offload Artificial Intelligence (AI) or machine learning tasks to end-nodes, thus enabling execution of the analysis of sensor data to be processed locally, (i.e., near the sensors where physical signals are collected). In this way, human-environment interactions with an edge device (e.g., a mobile device) can be met with low latency responses to users' inputs, since data does not need to travel to a centralized data center or cloud to be analyzed.

However, there are a few problems that may endanger the sustainability and effectiveness of edge computing. First, widely adopted AI techniques have, in several cases, an unfavorable trade-off between performance (i.e., accuracy) and hardware complexity. For instance, Convolutional (CNNs) and Recurrent Neural Networks (RNNs) are two of the most popular methods that are used in the context of image recognition and time series analyses, respectively. Although such solutions are capable of achieving high accuracy, the amount of data such methods process per operation may be on the order of several megabytes and can result in slow processing on general purpose CPU (central control units) on an edge system or another computing system.

General purpose FPGA platforms may be used in signal processing applications due to their ability to create versatile digital platforms and capability to achieve high compute capabilities. Despite the broad use in the computing field, they may not be fully optimized for the compute density or speeds desired for high performance computing (e.g., wideband processing and machine learning algorithms).

### BRIEF DESCRIPTION OF THE DRAWINGS

FIG. 1 is a block diagram illustrating an example of a tightly coupled accelerator (TCA) integrated with a CPU core.

FIG. 2 is a diagram illustrating an example of a previously existing deep neural network (DNN) model.

FIG. 3 is a block diagram illustrating an example computation flow of a DNN on a FPGA-based CPU and a CFU overlay model.

FIG. 4A is a block diagram illustrating an example of filters that are stored inside ordered memories and input data entries stored in buffers that are aware of the useful life of the input data entries.

FIG. 4B is a flowchart illustrating an example process for the CPU to use the accelerator.

FIG. 5A is block diagram illustrating an example of a previously known conventional FPGA accelerator system.

FIG. 5B illustrates a flowchart of a previously known process for the CPU to use the accelerator.

FIG. 6 is a block diagram illustrating an example of a memory buffer, where the data that are no longer needed are identified outside an input window and new data is only written over previously used input data.

FIG. 7 is a flowchart illustrating a method for data transfer when processing a deep neural network.

FIG. 8 is a flowchart illustrating a method of data transfer when processing a program segment.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

The present technology may provide data transfer optimization for field programmable gate arrays (FPGAs) with accelerators that are used to process deep neural networks. An example architectural model for a tightly coupled hardware accelerator will now be described. A tightly-coupled accelerator (TCA) may include a specialized hardware function unit which can hardware accelerate critical portions of an application kernel, such as a deep neural network (DNN). For example, the body of a processing loop (e.g., an inner loop) for a process can be accelerated. This type of accelerator may be located inside the CPU core, very close to the CPU or tightly integrated with the CPU.

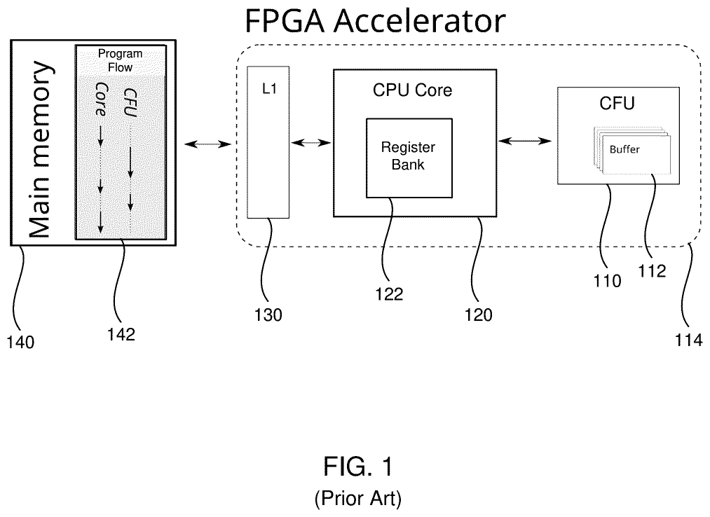

FIG. 1 is a diagram illustrating an example of a tightly coupled accelerator (TCA) 110 or Custom Function Unit (CFU) integrated with a CPU core 120. The CPU core 120 may share key resources with the TCA (i.e., the register bank 122 and L1 data cache 130), and thus the CPU core 120 processing may stall until the TCA 110 completes execution. TCAs do not require internal storage apart from internal status registers, since they may use the L1 cache 130 to hold data. L1 cache misses are served by the memory caching hierarchy on behalf of the coupled CPU core 120.

The TCA 110 may use an expansion of the ISA (instruction set architecture) to include special instructions to manage the accelerator's operation. This ISA expansion usually percolates to software via the compiler or through low-level libraries.

In one example, this technology may be used to accelerate machine learning processes such as deep neural networks. One aspect of this accelerator architecture in FIG. 1 is that the DNN (deep neural network) parameter data and input data can be stored in the main memory 140 in a portion of the main memory separate from a program. The main memory data may be transferred to the CPU core's register bank 122 whenever this data is needed using the bus between the main memory and the FPGA accelerator 114. The accelerator 110 can transfer output from CPU core's registers to the main memory 140 to store data (for example using layer output).

An accelerator that is a custom function unit will now be discussed. A “CFU”, or a “Custom Function Unit” 110 is an accelerator tightly coupled with the CPU core 120. This CFU may use custom instructions added to the ISA using a defined format. The CFU execution can be triggered by one of the defined instructions, with arguments passed via registers. The interaction between the CPU and the CFU is via registers and immediate values provided in the instruction itself. There is no direct memory access nor any interaction between different CFUs. The CPU can handle a plurality of CFUs with various functions, and the IDs of the CFUs may be retrieved from the operands of the decoded instruction.

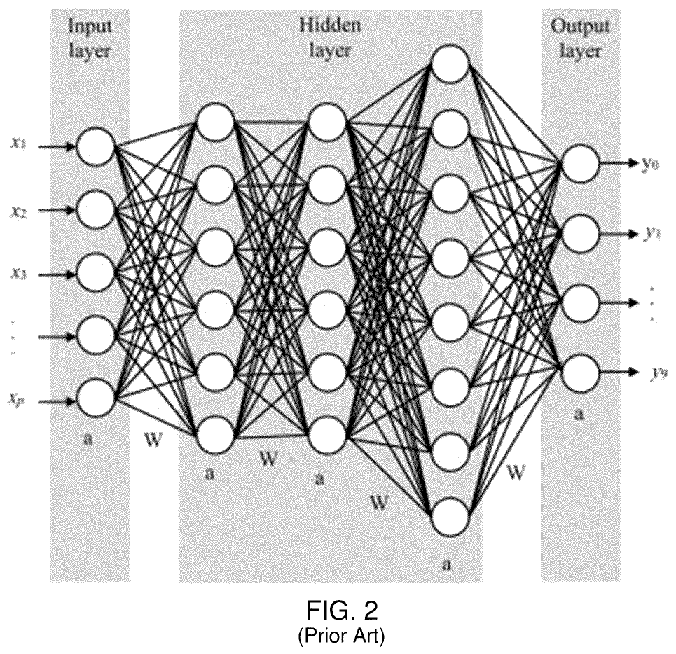

FIG. 2 illustrates an example of an existing type of a deep neural network. Deep neural networks are a class of machine learning algorithms that are implemented by stacking layers of neural networks along the depth and width of smaller architectures. Each layer consists of a number of neurons. Each neuron can transmit the sum of its inputs as multiplied by weighting values on to the inputs of the next layers. These values are called network parameters.

### FPGA-based CFU Accelerator for DNN Application

As machine learning engineers create new models with more complex dataflows and structures to push the accuracy boundaries of many types of applications, the uses for adaptive accelerators becomes greater. Designing custom function units (CFUs) for specific ML (machine learning) operations that can be implemented via a processor as an FPGA overlay can provide useful results. In this way, a small amount of custom hardware that exploits the bit-level flexibility of an FPGA can help accelerate large portions of ML execution time.

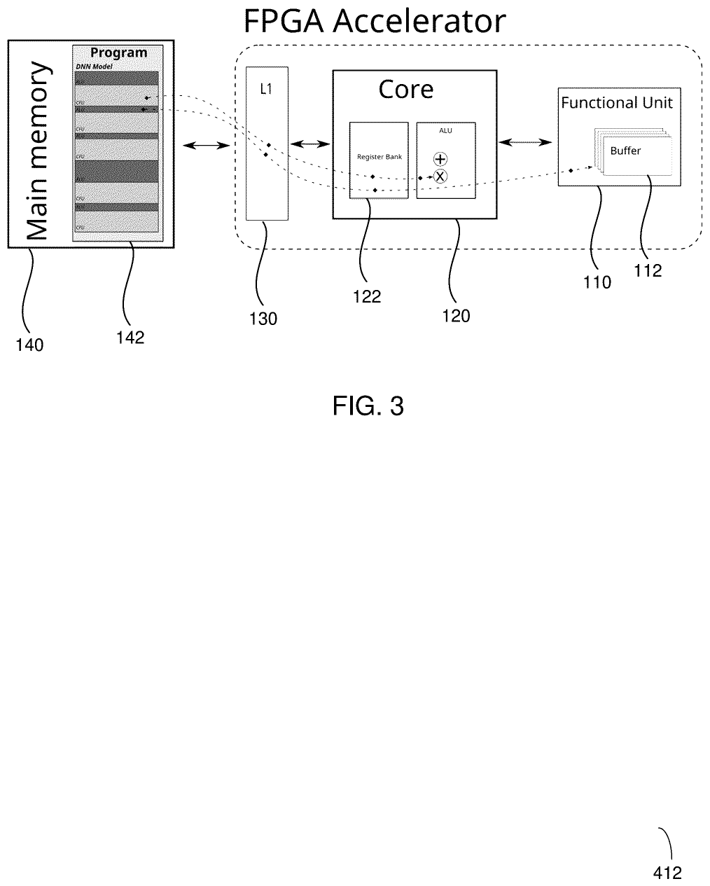

A typical CFU has a computational component as well as a memory component. CFU memory typically combines several independent BRAM banks of an FPGA to form multi-ported memories of sizes tailored to the CFU's needs. This arrangement may unleash the parallelism inherent in the kernels they accelerate by instantiating these tailored many-ported memories. Whereas, the granularity of CFU data is at the cache line size and their parallelism is severely constrained by the unavoidably low number of ports of L1 caches. This issue is compounded when considering the acceleration of complex applications, of which some parts are implemented in software and others are accelerated in hardware. FIG. 3 illustrates an example of the computational flow of a DNN on FPGA-based CPU and a CFU overlay model.

The present technology may have parallel distributed memory. This parallel arrangement may include placing data in different FPGA BRAMs within the buffer structure 112, as well as reducing the possibility of splitting up data that is related into different parts of the memories. This simplifies the design. Data distribution within the FPGA can then increase the amount of data loaded per clock, allowing for more calculations per clock.

In a more specific example, the filter data (i.e., parameter data) and/or input data being stored may be reordered. The reordering technique can change the order of DNN parameters during the main memory to CFU buffer transfer. The DNN parameter memory layout can be changed when transferring data from main memory to the CFU in order to store interdependent portions of the parameters that are computationally close to each other. Independent parts are calculated independently of one another to reduce the amount of memory used to store network parameters. This modification allows for greater use of parallelism within the FPGA-based CFU.

In another configuration, fine grained temporally-aware data buffering may be used. This technique provides multiple uses of data via DNN parameters and input data during CFU computation. To reduce data transfer, saving data for re-use is an existing technique called data buffering, as illustrated in FIG. 3. But saving data for buffering input data for a hardware accelerator is more complicated (e.g., for use in high performance computing). Usually, the volume of input data is so large that it is impossible to fit all the data inside the memories inside the FPGA chip (especially for a low-cost FPGA chip). In this situation, one way to use input data buffering is to remove data that is no longer needed, which reduces the buffer size used and allows buffering operations on input data. Because buffer patterns are directly affected by buffer organization, many buffer organizations are designed in isolation from the underlying data flow (or assume a simple data flow), potentially missing out on optimization opportunities. However, a co-design approach to the CPU side algorithm and buffer organization can be used. Buffers may then be aware that the data contained within them can be reused, and a writing policy may be provided based on that reuse knowledge. In fact, this reuse may be a solution for reducing data transfer, which reduces inference time and increases efficiency.

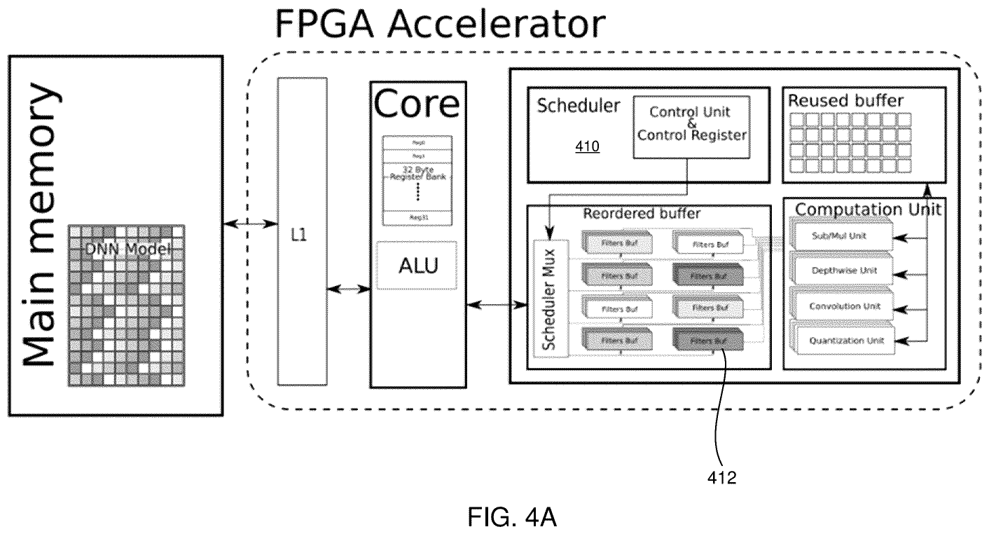

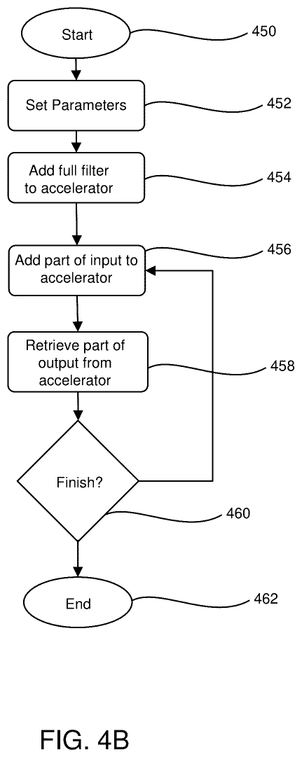

FIG. 4A illustrates that filters are stored inside ordered buffers 412 by the scheduler 410. Entries or input data stored in ordered buffers are aware of the useful life of the entries. These ordered buffers 412 can buffer more data than cache memories with the same amount of capacity.

FIG. 4B illustrates an example process for the CPU to use the accelerator. Initially the process may start 450 and the parameters 452 for the machine learning process may be set by the process. A copy of the full filter 454 may then be loaded into the hardware accelerator. A portion of the input values may be input or added to the hardware accelerator 456. At this point the accelerator may compute the machine learning process for the given inputs. The output from the accelerator may then be retrieved from the hardware accelerator. The process may the check to see if the processing of all the input is complete. If more inputs are available to be loaded, then the process can loop back to add 456 more inputs. If all the inputs to the hardware accelerator are processes then the method may end 462.

### Prior Approaches

Prior accelerator techniques using CFUs have tended to focus on the performance efficiency gains that the CFUs can provide via parallelization, with little consideration given to other practical issues, such as accelerator interaction with the CPU core. Unfortunately, much of the existing accelerator research has focused on computational aspects while ignoring design decisions with practical implications, such as the model for accelerator invocation from software and the interaction between the accelerator and the general-purpose core nearby (e.g., data transfer).

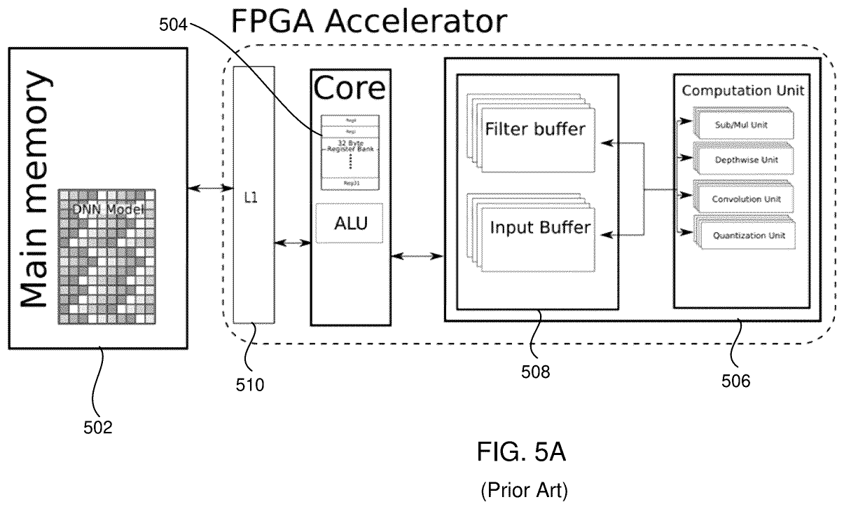

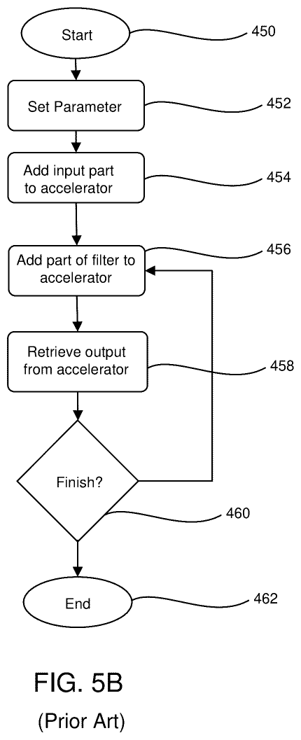

In order to compute or infer the neural network layers in conventional accelerators, the CPU must first transfer the filter parameter data and the input data from main memory 502 to the CPU registers 504, as shown in FIG. 5A. Then the filter parameter data and the input data are sent to the accelerator 506, which performs the convolution operations. Because the memory buffers 508 inside the accelerator 506 have a limited capacity, the CPU must transfer the input data and filter data several times if the filter data or input data is to be used multiple times. For example, if a filter must be multiplied by all input data, that filter must be moved from main memory 502 to the CFU buffer 508 every time the buffer is filled. In the meantime, the data and data close to the filter data are stored in the cache memory L1 510, so that it can possibly answer the next requests without asking the main memory to speed up the data request.

Despite the presence of a cache memory (L1) 510 between the main memory 502 and the accelerator 506, there is still a need to transfer duplicate data from the cache memory 510 to the CFU accelerator 506 due to the small size of the cache memory 510 and duplicate data requests in separate requests with relatively long intervals between the separate requests. Furthermore, because the CFU buffer memory 508 is unaware of the data in the buffer memory or the time required for the data to transfer, it operates inefficiently. In other words, data may enter the buffer memory 508 because the data is close to other data (i.e., the targeted data), but some of this data may never be used, frequently causing unused data to be deleted from the buffer memory.

FIG. 5A further illustrates that due to the non-optimal use of buffers and the large size of the model, the conventional accelerator is forced to transfer information several times. FIG. 5B illustrates a flow chart of a process for the CPU to use the accelerator (i.e., similar to FIG. 4B).

### Problem Formulation

The time used to execute a neural network inference may be equal to the sum of the times it takes to compute each layer Ti. The following may estimate the time spent in each layer:

$${T}_{total} = {\sum }_{i = 1}^{n} {T}_{i}$$

$${T}_{i} = {T}_{send data} + {T}_{receive data} + {T}_{cpu process} + {T}_{accelerator process}$$

$${T}_{senddata} = {\sum }_{i}^{i ∈ input} CacheHit * {T}_{cache} + MemoryHit * {T}_{memory}$$

Increasing the size of the machine learning model compared to the size of the cache leads to an increase in the memory hits (i.e., MemoryHit) when accessing the caching system and a decrease in cache hits (i.e., CacheHit). Since T_{memory} is larger than T_{Cache}, increasing the size of the machine learning model increases the value of T_{send data}.

Tₜₒₜₐₗ may be reduced by decreasing the total send time of the data or T_{senddata}. One way to reduce T_{senddata} is to avoid sending duplicate data. The transfer of data that will be needed later may be avoided by saving data needed in the future in the buffer. However, with the previously used strategy of storing data in the cache and the cache-to-model size ratio, this can be unworkable.

The data arrangement in main memory can be incompatible with parallel processing in hardware. Thus, when data is transferred from main memory 502 to the accelerator 506, its order may be changed from the state suitable for execution in systems with non-aware caches to the desired state for the accelerator using a scheduler. When writing the layer's output in order to use the layer's result in subsequent layers, the data can be converted to a pre-defined form using a scheduler.

### Data Reordering

The present technology may contain a data reordering and a data reusing technique. The data reordering will be described further here. Considering the amount of references to main memory and effect of the main memory on the performance, as presented earlier, one of the ways to speed up processing of machine learning models, such as a neural network layer, is to remove the transmission of repetitive elements. For this purpose, a number of BRAMs may be added to the accelerator to store data that is needed more than once. However, to solve the problem of the small size of these BRAMs compared to the size of the model, the order of storing parameters and the order of performing calculations can be changed. The volume of input data is much larger than the total on-chip memory, so all the input data cannot be stored in the on-chip memory to perform buffer operations.

The calculations of a layer may be divided into several smaller parts that are independent of each other in terms of calculations using the parameters and input data, and each part of the calculations can be calculated separately. Independence of the data values or parameters or computation independence can also be defined to include data values and/or parameters that have little dependence on other data values or parameters. This way only the data of that independent part can be stored in the accelerator memory during an accelerator computation cycle. This means that less memory is used and the data is not transmitted repeatedly. In this way, the accelerator buffers the computations with a smaller amount of memory than would be needed for all of the input data. This arrangement can also change when the data may be moved from the main memory to the BRAM by a scheduler. In one example, the accelerator can perform the basic operation of a deep neural network, which is multiplication, using DSPs. This improvement can also be applied to other computing processes which have repetitive portions and independent data segments to be processed such as a data processing loops or other parallel processing computations.

The scheduler may place the data in the BRAMs for parallel processing. To take advantage of the FPGA's parallelization capabilities, the accelerator can distribute the data across multiple BRAMs in order to access a large amount of data in each clock cycle. If the maximum amount extracted by each BRAM Q is W bits and the size of each data value (e.g., an integer, float, character, etc.) is K bits, the accelerator can extract W*Q/K data elements from BRAMs once every clock by using Q BRAM.

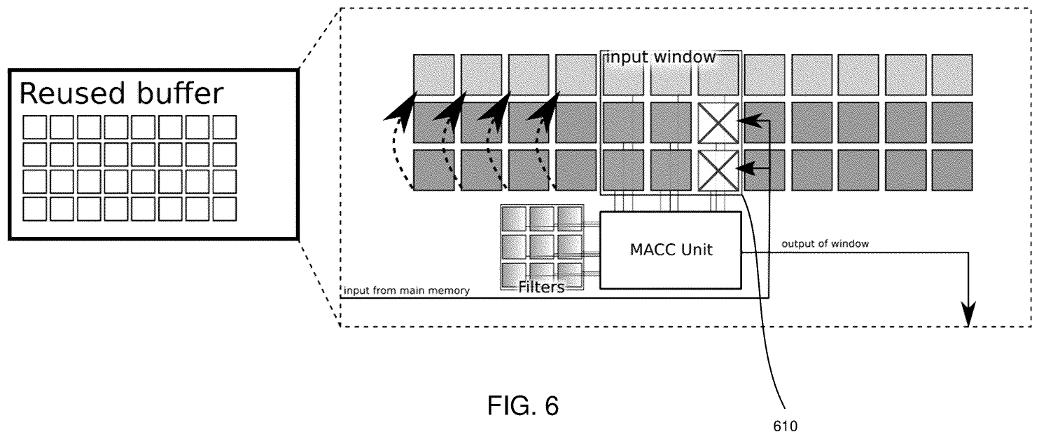

Fine grained temporally-aware data buffering can also be provided. Unlike filter data, input data cannot be buffered in BRAM through reordering. This is significant for two reasons:
The volume of this input data is enormous (much more than the filter data in most cases),
In some cases, the time used to store input data, even two adjacent input data, varies. For example, in a convolution operation with stride 2 (e.g., in an image or video), the amount of time used to retain even line entries differs from that used to retain odd line entries. Given the foregoing, it is valuable for the input data to be writable immediately after the last use, as well as reordered. The data consumption pattern for different inputs can be implemented in the accelerator so that the accelerator does not have to keep data that is no longer expected to be used (FIG. 6), which resides in the cache and reduces the performance of the cache. FIG. 6 illustrates that inside the buffer, the data that are no longer needed are identified and new data is written only over this data. More specifically, input data that is no longer needed may be identified using an input window 610 to identify input data that is outside the window and has already been processed. Then new data can be written into the input window 610 as illustrated by the boxes marked with an X.

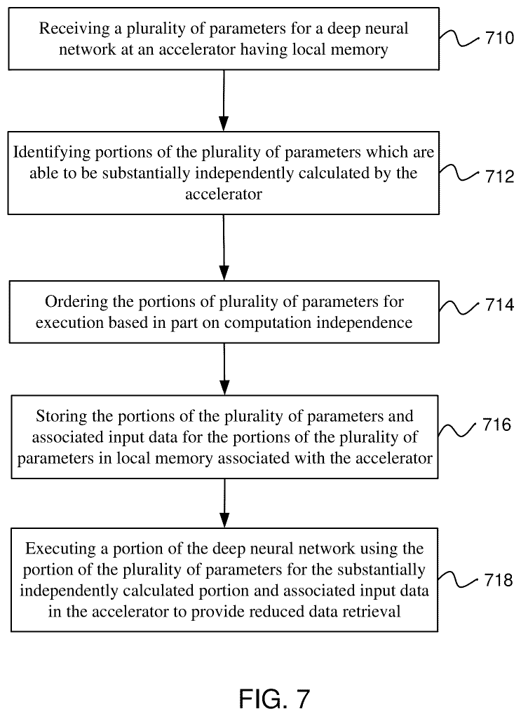

FIG. 7 is a flowchart illustrating a method for data transfer when processing a deep neural network. The method may include receiving a plurality of parameters for a deep neural network at an accelerator having local memory, as in block 710. The local memory may be a plurality of BRAMs having dual ports.

Portions of the plurality of parameters may be identified which are able to be independently calculated by the accelerator, as in block 712. The portions of plurality of parameters may be ordered for execution based in part on computation independence, as in block 714. Further, the input data for the deep neural network may be ordered in the local memory buffer of the accelerator so that the input data can be rewritten immediately after being used in executing the deep neural network. The plurality of parameters may also be distributed across the plurality of local memory buffers to enable parallel processing of the plurality of parameters to occur.

The portions of the plurality of parameters and associated input data for the portions of the plurality of parameters may be stored in local memory associated with the accelerator, as in block 716. In one example, the portion of the plurality of parameters may be equivalent to a convolution of the deep neural network or a loop in a program.

A portion of the deep neural network may be executed using the portion of the plurality of parameters for the independently calculated portion and associated input data in the accelerator to provide output data while processing the portion of the plurality of parameters with reduced data retrieval, as in block 718. The execution may include performing multiply and accumulate operations for the deep neural network using digital signal processors (DSP) in the accelerator. Input data that is no longer needed may be identified using an input window to identify input data that is outside the window and has already been processed.

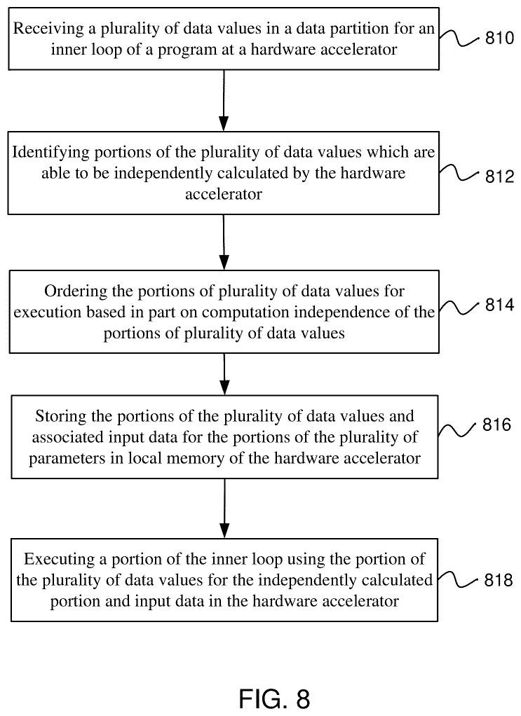

FIG. 8 is a flow chart illustrating a method of data transfer when processing a program segment. The method may include the operations of receiving a plurality of data values in a data partition for an inner loop of a program at a hardware accelerator having local memory, as in block 810. The local memory may be a plurality of BRAMs having dual ports.

Portions of the plurality of data values may be identified which are able to be independently calculated by the hardware accelerator, as in block 812. One portion of the plurality of data values may be equivalent to: a convolution of the deep neural network, a loop in a program or a single execution branch of a program.

The portions of plurality of data values may be ordered for execution based in part on computation independence of the portions of the plurality of data values, as in block 814. For example, input data for the program segment may be ordered in the local memory buffer of the accelerator so that the input data can be rewritten immediately after being used in executing the program segment. Input data may be identified that is no longer needed using an input window to identify data that is outside the window and has already been processed.

The portions of the plurality of data values and associated input data for the portions of the plurality of parameters may be stored in local memory associated with the hardware accelerator, as in block 816.

A portion of the inner loop may be executed using the portion of the plurality of data values for the independently calculated portion and associated input data in the hardware accelerator to provide output data while processing the portion of the plurality of data values with reduced data retrieval, as in block 818. The arithmetic operations for the program segment may be performed using digital signal processors (DSP) in the accelerator.

Some of the functional units described in this specification have been labeled as modules or are shown in blocks, in order to more particularly emphasize their implementation independence. For example, a module or block may be implemented as a hardware circuit comprising custom VLSI circuits or gate arrays, off-the-shelf semiconductors such as logic chips, transistors, or other discrete components. A module or block may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method of data transfer when processing a deep neural network, comprising:
receiving a plurality of parameters for a deep neural network at an accelerator having local memory;
identifying portions of the plurality of parameters which are able to be independently calculated by the accelerator;
ordering the portions of plurality of parameters for execution based in part on computation independence;
storing the portions of the plurality of parameters and associated input data for the portions of the plurality of parameters in local memory associated with the accelerator; and
executing a portion of the deep neural network using a portion of the plurality of parameters able to be independently calculated and associated input data in the accelerator to provide output data from processing the portion of the plurality of parameters with reduced data retrieval.

2. The method as in claim 1, wherein the portion of the plurality of parameters is equivalent to at least one of: a convolution of the deep neural network or a loop in a program.

3. The method as in claim 1, further comprising ordering input data for the deep neural network in the local memory of the accelerator so that the input data can be rewritten immediately after being used in executing the deep neural network.

4. The method as in claim 1, further comprising performing multiply and accumulate operations for the deep neural network using digital signal processors (DSP) in the accelerator.

5. The method as in claim 1, wherein the local memory is a plurality of BRAMs having dual ports.

6. The method as in claim 1, further comprising identifying input data that is no longer needed using an input window to identify data that is outside the input window and has already been processed.

7. The method as in claim 1, wherein the plurality of parameters are distributed across a plurality of local memories to enable parallel processing of the plurality of parameters to occur.

8. A system for improvement of data transfer when processing a deep neural network, comprising:
at least one processor;
at least one memory device including a data store to store a plurality of data and instructions that, when executed, cause the system and processor to:
receive a plurality of parameters for a deep neural network at an accelerator having local memory;
identify portions of the plurality of parameters which are able to be independently calculated by the accelerator;
order the portions of plurality of parameters for execution based in part on computation independence;
store the portions of the plurality of parameters and associated input data for the portions of the plurality of parameters in local memory associated with the accelerator; and
execute a portion of the deep neural network using a portion of the plurality of parameters able to be independently calculated and associated input data in the accelerator to provide output data using a self-contained computation.

9. The system as in claim 8, wherein the portion of the plurality of parameters is equivalent to a convolution of the deep neural network.

10. The system as in claim 8, further comprising ordering input data for the deep neural network in the local memory of the accelerator so that the input data can be rewritten immediately after being used for executing the deep neural network.

11. The system as in claim 8, further comprising performing multiply and accumulate operations for the deep neural network using digital signal processors (DSP) in the accelerator.

12. The system as in claim 8, wherein the local memory is a plurality of BRAMs having dual ports.

13. The system as in claim 8, further comprising identifying input data that is no longer needed using an input window to identify data that is outside the input window and has already been processed.

14. The system as in claim 8, wherein the plurality of parameters are distributed across a plurality of local memories to enable parallel processing of the plurality of parameters to occur.

15. A method of data transfer when processing a program segment, comprising:
receiving a plurality of data values in a data partition for an inner loop of a program at a hardware accelerator having local memory;
identifying portions of the plurality of data values which are able to be independently calculated by the hardware accelerator;
ordering the portions of plurality of data values for execution based in part on computation independence of the portions of the plurality of data values;
storing the portions of the plurality of data values and associated input data for the portions of the plurality of data values in local memory associated with the hardware accelerator; and
executing a portion of the inner loop using a portion of the plurality of data values able to be independently calculated and associated input data in the hardware accelerator to provide output data while processing the portion of the plurality of data values with reduced data retrieval.

16. The method as in claim 15, wherein the portion of the plurality of data values is equivalent to at least one of: a convolution of a deep neural network, a loop in a program or a single execution branch of a program.

17. The method as in claim 15, further comprising ordering input data for the program segment in the local memory of the accelerator so that the input data can be rewritten immediately after being used in executing the program segment.

18. The method as in claim 15, further comprising performing arithmetic operations for the program segment using digital signal processors (DSP) in the accelerator.

19. The method as in claim 15, wherein the local memory is a plurality of BRAMs having dual ports.

20. The method as in claim 15, further comprising identifying input data that is no longer needed using an input window to identify data that is outside the input window and has already been processed.
